(19) United States
(12) Patent Application Publication
(10) Pub. No.: US 2023/0060959 A1
(43) Pub. Date: Mar. 2, 2023

(54) Animal Leash Safety Strap Device

(71) Applicant: Ernest Hood, Henderson, NV (US)

(72) Inventor: Ernest Hood, Henderson, NV (US)

(21) Appl. No.: 17/524,807

(22) Filed: Nov. 12, 2021

Related U.S. Application Data
(60) Provisional application No. 63/240,091, filed on Sep. 2, 2021.

(51) Int. Cl. A01K 27/00

(52) U.S. Cl. CPC A01K 27/004

(57) ABSTRACT

The present invention relates generally to the field of animal leashes. More specifically, the present invention relates to an animal leash safety strap device. The device is primarily comprised of a leash, a leash housing and a safety strap. The safety strap can be secured around the wrist and/or hand of the user during use, such that the leash housing cannot be dropped by a user while it is being used to walk an animal. In this manner, a user can secure the strap around his or her wrist and/or hand and have a backup or fail-safe in the event the animal leash fails due to user error or the unexpected movement of an energetic pet.

### CROSS-REFERENCE TO RELATED APPLICATION

The present application claims priority to, and the benefit of, U.S. Provisional Application No. 63/240,091, which was filed on Sep. 2, 2021 and is incorporated herein by reference in its entirety.

### FIELD OF THE INVENTION

The present invention relates generally to the field of animal leashes. More specifically, the present invention relates to an animal leash safety strap device. The device is primarily comprised of a leash, a leash housing and a safety strap. The safety strap can be secured around the wrist and/or hand and/or hand of the user during use such that the leash housing cannot be dropped by a user while it is being used to walk an animal. In this manner, a user can secure the strap around his or her wrist and/or hand and/or hand and have a backup or fail safe in the event the animal leash fails due to user error or the unexpected movement of an energetic pet. Accordingly, the present disclosure makes specific reference thereto. Nonetheless, it is to be appreciated that aspects of the present invention are also equally applicable to other like applications, devices and methods of manufacture.

### BACKGROUND

Many individuals enjoy walking their pets, whether it is for a hobby or for the health of both the pets and the owners. Others even walk pets as a job. However, as most pet owners have experienced, anxious or high energy pets that can pull or act erratically at times while being walked on a leash. Additionally, when pets become loose from a leash and run away, they prove to be a safety hazard for both themselves and other nearby individuals. In many cases, a pet may bite or attack someone else or their pet(s). They may also run into traffic, which would also lead to their safety being compromised alongside the pet owner and car driver(s). Further, some individuals may only have the ability to walk their pet during the dark hours of the morning or night. During these hours, visibility is limited, and if the individual does not wear reflective clothing, they may not be seen by motorists and may be accidently struck by said motorists.

Therefore, there exists a long-felt need in the art for an improved animal leash. There also exists a long-felt need in the art for an animal leash safety strap device that allows a user to retain control of the original leash via a secondary measure of safety. Further, there exists a long-felt need in the art for an animal leash safety strap device that allows a leash to be secured to a user's wrist and/or hand and/or hand. Finally, there exists a long-felt need in the art for an animal leash safety strap device that ensures a user and a pet are visible while walking in dark environments.

The subject matter disclosed and claimed herein, in one embodiment thereof, comprises an animal leash safety strap device. The device is primarily comprised of a leash, a leash housing, and a safety strap. The safety strap can be secured around the wrist and/or hand and/or hand of the user during use, such that the leash housing cannot be dropped by a user while it is being used to walk an animal. In this manner, a user can secure the strap around their wrist and/or hand and/or hand and have a backup or fail safe in the event the animal leash fails due to user error or the unexpected movement of an energetic pet.

In this manner, the animal leash safety strap device of the present invention accomplishes all of the forgoing objectives and provides an improved device that can be used while walking or handling pets. Further, the device creates an added measure of control over one or multiple pets. As a result, a user is more likely to have better control over their pets regardless of whether the pets are anxious or high energy. In addition, this device ensures that the user maintains control over their pets at all times, even in the event of a user error where the user may accidentally let go of the leash.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal leash safety strap device. The device is primarily comprised of a leash, a leash housing, and a safety strap. The safety strap has a first end comprised of a strap or loop, allowing the user to attach the device securely to his or her wrist and/or hand. The second end is further comprised of a small strap or loop that fixedly or removably-attaches it to an animal leash that may also be part of the invention in one embodiment. The leash housing further houses the leash, which can be retracted or pulled from the housing via an internal reel. The housing, leash and/or safety strap may further be comprised of a glow-in-the-dark coating and/or at least one LED used to illuminate the housing, leash, and/or safety strap while the device is being used in dark environments.

To use the device, a user first tightly secures the device onto to leash device using a fastener which is attached to the second end of the safety strap. Once secure, the user then inserts his or her hand through the first end, through the loop and uses an adjustable fastener to tighten the loop around their wrist and/or hand. As a result, users can then maintain better and more secure control over their pet(s). With the pet(s) secured to the leash and the leash housing secured to a user's wrist and/or hand, the user has an improved level of control such that they can still retain the leash housing even if the housing is dropped.

Accordingly, the animal leash safety strap device of the present invention is particularly advantageous as it provides an improved device that allows a user to securely control his or her pet while walking the pet on a leash. The animal leash safety strap device also allows a leash to be secured to a user's wrist and/or hand and ensures a user and a pet are visible while walking in dark environments. Therefore, the animal leash safety strap device overcomes the limitations of existing leashes and methods of walking a pet known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an animal leash safety strap device of the present invention in accordance with the disclosed architecture;

FIG. 2 illustrates a perspective view of one potential embodiment of an animal leash safety strap device of the present invention attached to a wrist and/or hand of a user in accordance with the disclosed architecture; and

FIG. 3 illustrates an enhanced perspective view of one potential embodiment of a strap of one potential embodiment of an animal leash safety strap device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved animal leash. There also exists a long-felt need in the art for an animal leash safety strap device that allows a user to retain control of the original leash via a secondary measure of safety. Further, there exists a long-felt need in the art for an animal leash safety strap device that allows a leash to be secured to a user's wrist and/or hand. Finally, there exists a long-felt need in the art for an animal leash safety strap device that ensures a user and a pet are visible while walking in dark environments.

The present invention, in one exemplary embodiment, is comprised of an animal leash safety strap device primarily comprised of a leash, a leash housing and a safety strap. The safety strap has a first end comprised of a strap or loop, allowing the user to attach the device securely to his or her wrist and/or hand. The second end is further comprised of a small strap or loop that fixedly or removably-attaches it to an animal leash that may also be part of the invention in one embodiment. The leash housing further houses the leash, which can be retracted or pulled from the housing via an internal reel. Additionally, the housing, leash and/or safety strap may further be comprised of a glow-in-the-dark coating and/or at least one LED used to illuminate the housing, leash and/or safety strap while the device is being used in dark environments.

When using the device, a user first tightly secures the device onto the leash device using a fastener which is attached to the second end of the safety strap. Once secure, the user then inserts his or her hand through the first end, through the loop, and uses an adjustable fastener to tighten the loop around his or her wrist and/or hand. As a result, users can then maintain better and more secure control over their pet(s). With the pet(s) secured to the leash and the leash housing secured to a user's wrist and/or hand, the user has an improved level of control, such that they can still retain the leash housing even if the housing is dropped.

Accordingly, the animal leash safety strap device of the present invention is particularly advantageous as it provides an improved device that allows a user to securely control his or her pet while walking the pet on a leash. The animal leash safety strap device also allows a leash to be secured to a user's wrist and/or hand and ensures a user and a pet are visible while walking in dark environments. Therefore, the animal leash safety strap device overcomes the limitations of existing leashes and methods of walking a pet known in the art.

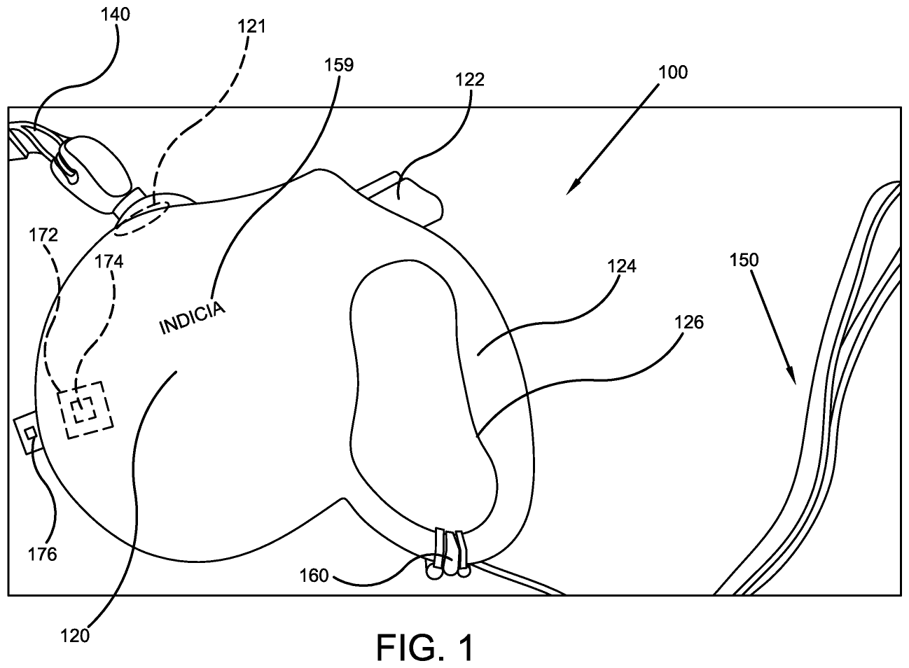

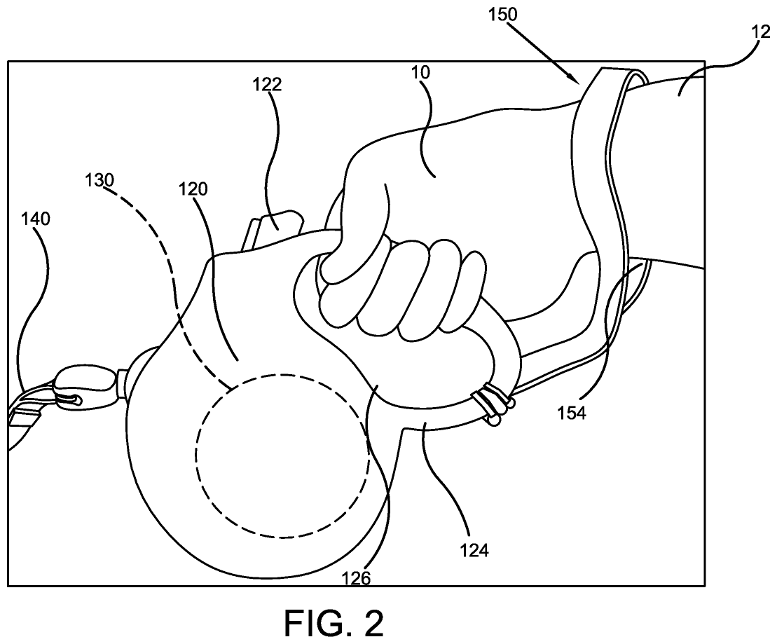

Referring initially to the drawings, FIG. 1 illustrates a perspective view of one potential embodiment of an animal leash safety device 100 of the present invention in accordance with the disclosed architecture. The device 100 is primarily comprised of a leash 140, a leash housing 120 and a safety strap 150. The leash housing 120 is preferably manufactured from a rigid plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. The housing 120 has an internal spinning reel 130 that receives a leash 140, wherein the leash 140 can be retracted around the reel 130 through a continuous opening 121 in the housing 120 to allow the leash 140 to become shorter in length. The leash 140 may also be pulled from the housing 120 (e.g. by an animal while the leash 140 is attached to said animal) through the continuous opening 121 to allow the leash 140 to become longer in length. The leash 140 can further be locked at a specific length via at least one button 122. In a differing embodiment, the button 122 can be used to force the leash 140 to automatically retract into the housing 120 when pressed, in addition to allowing the leash 140 to lock. The housing 120 also has a handle 124 with a continuous opening 126 that allows a user to easily grip the housing 120 (as best seen in FIG. 2). Furthermore, the housing 120 may be comprised of any number of indicia 159—in the form of patterns, logos, emblems, images, symbols, designs, letters, words, characters, animals, advertisements, brands, etc. that may or may not be animal, pet, animal leash, or animal leash safety device-related.

The leash 140 is preferably made from a durable, artificial and/or synthetic fabric material such as, but not limited to, denim, velvet, polar fleece, chiffon, tartan, muslin, gingham, damask, crepe, chenille fabric, organza, poplin, felt, flannel, broadcloth, Georgette, terrycloth, taffeta, corduroy, hessian fabric, tweed, velour, brocade, sateen, charmeuse, chino cloth, gabardine, stretch fiber, alpaca fiber, ticking, bengaline, dobby, organdy, Kevlar, etc. The leash 140 may additionally or alternatively be made of an elastic, plastic, or a mixture polymer material such as, but not limited to, stretch cotton poplin, jersey knits, Lycra, spandex, elastane, neoprene rubber, nylon, power mesh, stretch chiffon, stretch cotton jacquard, polyester, cotton, nylon, a blend of fiber threads, etc. The leash 140 and housing 120 may also be transparent, semi-transparent or opaque in differing embodiments.

Additionally, in one embodiment of the device 100, the housing 120, strap 150, and/or leash 140 may be coated with a paint or other similar coatings, finishes or stains such that the entire body may glow or illuminate while in darkness. These materials can contain, but are not limited to, any and all coatings, finishes, stains or paints that include phosphor or other phosphorus chemicals or elements. These include, zinc, sulfates, strontium, aluminum, zinc sulfides, strontium aluminate, etc. These chemicals, when combined in with the aforementioned materials used for manufacturing the housing 120/leash 140 produce a glowing or illuminated surface. In addition, the housing 120, strap 150 and/or leash may be manufactured from a material that inherently has said glowing properties. With the addition of this feature, the visibility of the animal and pet owner at night would be increased, as both the pet and owner can be more easily seen by motorists or other nearby individuals. Therefore, the safety of a user and their pet while walking at night is greatly improved.

In another embodiment of the device 100, the housing 120, strap 150, and/or leash 140 may further be comprised of at least one LED light 170 on any surface of the housing 120, strap 150 and/or leash 140. The at least one LED light 170 is further powered by an internal battery 172. The LED light 170 further be attachable or detachable from the housing 120, strap 150, and/or leash 140. In an embodiment where the strap 150 is separable from the housing 120, a user would be able to detach the strap 150 with the LED light 170 from the housing 120 utilize the strap 150 to illuminate his or her wrist and/or hand 12. The battery 172 may be a disposable battery or a rechargeable battery in the form of an alkaline, nickel-cadmium, nickel-metal hydride battery, etc. such as any 3V-12 volts DC battery or other conventional battery such as but not limited to A, AA, AAA, AAAA, etc. that supply power to the LED light 170 and therefore the device 150. This includes other batteries that may be able to power larger and brighter or smaller and dimmer LED lights 170 including the aforementioned batteries and also cell-sized batteries. This may include batteries ranging anywhere from 4.5V large-sized batteries all the way to LR44 and CR2032 smaller-sized cell batteries. Throughout this specification the term “battery” may be used interchangeably to refer to one or more wet or dry cells or batteries of cells in which recharging or replacing the battery 172 may refer to recharging or replacing individual cells, individual batteries of cells or a package of multiple battery cells as is appropriate for any given battery technology that may be used. In a differing embodiment in which the LED light 170 supports the rechargeable function, the battery may be able to be recharged through the use of a USB port 174. The USB port 174, would exist on the LED light 170 itself and be used to recharge the on-board battery 172. The battery 172 may be recharged through a wide variety of USB ports 174. These ports include but are not limited to USB-A, USB-B, Micro-A, Micro-B, Micro-USB, Mini-USB, Mini-A, Mini-B, USB-Micro B Super Speed (BSS), USB-C ports, etc. The LED light 170 is further controlled through an On/Off (power) switch 176, which would give the user the ability to turn the LED light 170 on and off as needed.

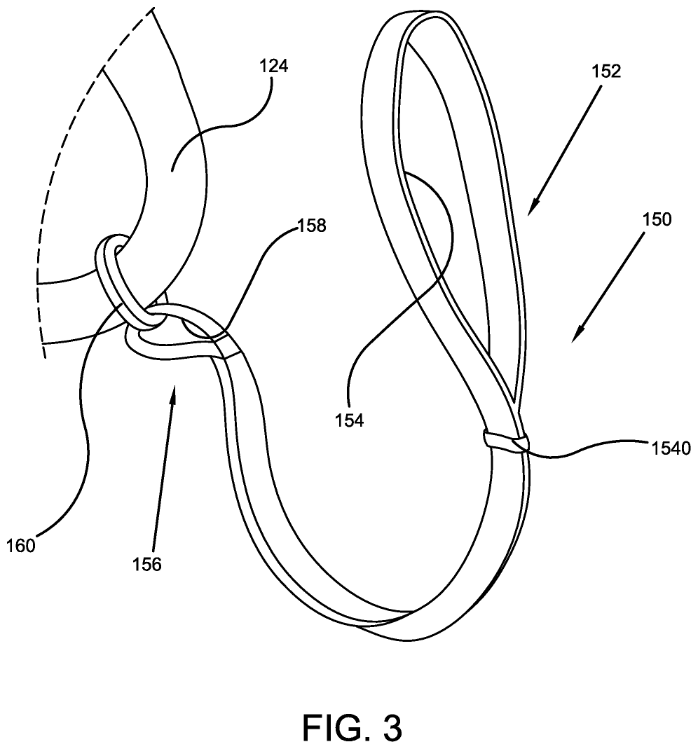

FIG. 3 illustrates a perspective view of one potential embodiment of an animal leash safety device 100 of the present invention in accordance with the disclosed architecture. The device 100 is also comprised of at least one safety strap 150 that attaches to the leash housing 120 via at least one fastener 160 on the handle 124 of the housing 120. In differing embodiments, the fastener 160 may be any fastener known in the art such as, but not limited to, hook and loop, zip tie, a tie down strap, adhesive, an elastic band, etc. The first end 152 of the strap 150 has a loop 154 which allows the users to attach the strap 150 securely to their wrist and/or hand 12 (as seen in FIG. 2). The user can further securely attach the device 100 around their wrist and/or hand 12 by using at least one adjustable fastener 1540 located on the strap 150 to tighten the strap 150 around the wrist and/or hand 12. In differing embodiments, the at least one adjustable fastener 1540 may be any adjustable fastener known in the art such as, but not limited to, a locking clip, a ladder lock or other lock of the like, etc. The second end 156 of the strap 150 further has a fixed or adjustable-size loop 158 that attaches around the fastener 160 located on the handle 124. In the preferred embodiment, the loop 158 is attached to the fastener 160, and the fastener 160 is then attached around the handle 124. Although, in one embodiment the strap 150 may be fixedly-attached to the handle 124 and/or housing 120 without the use of a fastener 160. In differing embodiments, the strap 150 may be manufactured from a plurality of material such as but not limited to: artificial and/or synthetic fabric material such as, but not limited to, nylon, denim, velvet, polar fleece, chiffon, tartan, muslin, gingham, damask, crepe, chenille fabric, organza, poplin, felt, flannel, broadcloth, Georgette, terrycloth, taffeta, corduroy, hessian fabric, tweed, velour, brocade, sateen, charmeuse, chino cloth, gabardine, stretch fiber, alpaca fiber, ticking, bengaline, dobby, organdy, Kevlar, etc

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “animal leash safety strap device” and “device” are interchangeable and refer to the animal leash safety strap device 100 of the present invention.

Notwithstanding the forgoing, the animal leash safety strap device 100 of the present invention and its various components can be of any suitable size and configuration as is known in the art without affecting the overall concept of the invention, provided that they accomplish the above-stated objectives. One of ordinary skill in the art will appreciate that the size, configuration and material of the animal leash safety strap device 100 as shown in the FIGS. are for illustrative purposes only, and that many other sizes and shapes of the animal leash safety strap device 100 are well within the scope of the present disclosure. Although the dimensions of the animal leash safety strap device 100 are important design parameters for user convenience, the animal leash safety strap device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal leash safety strap device comprising:
a safety strap that can be attached to a handle of a retractable leash, wherein the safety strap is further comprised of a loop.

2. The animal leash safety strap device of claim 1, wherein the loop of the safety strap allows the animal leash safety strap device to remain secured to the user's hand in the event that the user drops the retractable leash.

3. The animal leash safety strap device of claim 1, wherein the loop of the safety strap allows the animal leash safety strap device to remain secured to the user's wrist in the event that the user drops the retractable leash.

4. The animal leash safety strap device of claim 1, wherein the safety strap is manufactured from a fabric material.

5. The animal leash safety strap device of claim 4, wherein the fabric material is a nylon material.

6. An animal leash safety strap device comprising:
a safety strap that can be attached to a handle of a retractable leash, wherein the safety strap is comprised of a loop and an at least one adjustable fastener.

7. The animal leash safety strap device of claim 6, wherein the at least one adjustable fastener that allows the loop of the safety strap to tighten around a wrist of a user.

8. The animal leash safety strap device of claim 6, wherein the at least one adjustable fastener that allows the loop of the safety strap to tighten around a hand of a user.

9. The animal leash safety strap device of claim 6, wherein the safety strap is manufactured from a fabric material.

10. The animal leash safety strap device of claim 9, wherein the fabric material is a nylon material.

11. The animal leash safety strap device of claims 7 and 8, wherein the loop of the safety strap allows the animal leash safety strap device to remain secured to the user's wrist and/or the user's hand in the event that the user drops the retractable leash.

12. An animal leash safety strap device comprising:
a safety strap that can be attached to a handle of a retractable leash via an at least one fastener, wherein the safety strap is comprised of a loop and an at least one adjustable fastener.

13. The animal leash safety strap device of claim 12, wherein the at least one adjustable fastener that allows the loop of the safety strap to tighten around a wrist of a user.

14. The animal leash safety strap device of claim 12, wherein the at least one adjustable fastener that allows the loop of the safety strap to tighten around a hand of a user.

15. The animal leash safety strap device of claim 12, wherein the safety strap is manufactured from a fabric material.

16. The animal leash safety strap device of claim 15, wherein the fabric material is a nylon material.

17. The animal leash safety strap device of claims 13 and 14, wherein the loop of the safety strap allows the animal leash safety strap device to remain secured to the user's wrist and/or the user's hand in the event that the user drops the retractable leash.

18. The animal leash safety strap device of claim 12, wherein the at least one fastener is a zip tie.
